(19) United States
(12) Patent Application Publication
(10) Pub. No.: US 2026/0030618 A1
(43) Pub. Date: Jan. 29, 2026

(54) SYSTEMS AND METHODS FOR PROCESSING PAYMENTS IN CRYPTOGRAPHIC CURRENCY

(71) Applicant: NAYAX LTD., Herzliya (IL)

(72) Inventors: David BEN-AVI, Herzliya (IL); Guy ROSENHOIZ, Herzliya (IL)

(21) Appl. No.: 18/997,481

(22) PCT Filed: Oct. 1, 2023
(86) PCT No.: PCT/IL2023/051050

§ 371 Date: Jan. 21, 2025

(30) Foreign Application Priority Data
Oct. 30, 2022 (IL) 297778

(51) Int. Cl. G06Q 20/38; G06Q 20/20; G06Q 20/36; G06Q 20/40

(52) U.S. Cl. CPC G06Q 20/381; G06Q 20/204; G06Q 20/36; G06Q 20/382; G06Q 20/4016

(57) ABSTRACT

A system for processing payments using cryptographic currency, comprising: a software development kit operably coupled with at least one crypto-wallet having at least one crypto-address; wherein, said SDK is configured to transmit a user ID and at least one crypto-address to a payment terminal and a server platform; a payment terminal configured to transmit to a server platform an invoice message comprising a payment amount in a first currency and the crypto-address or user ID; a server platform configured to query an at least one blockchain network for balance of an at least one cryptocurrency type in said at least one crypto-wallet, and establish a value of said at least one balance in the first currency by applying at least one available exchange rate with said at least one cryptocurrency type; said server platform responding to said invoice message by sending a crypto-payment offer message to said SDK, comprising at least one payment amount in said at least one cryptocurrency type.

### TECHNICAL FIELD

This disclosure generally relates to methods and systems for processing payments. More specifically, to methods and systems for processing payments with cryptographic currency.

### BACKGROUND

Although cryptocurrencies exist for more than a decade, they fall short of achieving the goal of serving as a widely used currency in day-to-day commercial scenarios.

There are many deficiencies that prevent cryptocurrencies from wide adoption by consumers including, high transaction costs, high latency of processing payments, and unusual diversity of cryptocurrency types forcing the use of different software for each. For Example, US 2020013046A1 provides an apparatus which stores information regarding accounts, and information regarding whether or not each account can be utilized to effectuate payment for a total cost of a transaction; a computer; a distributed ledger and Blockchain technology system; and a receiver. For example. WO2022212248A1 provides techniques for integrating a payment processing platform (PPP) and a payment making platform (PMP) for differentiated payment allocations using cryptocurrency. The PPP can receive a request to receive funds in cryptocurrency. Based on the request, a cryptocurrency wallet account for the merchant can be accessed. The PPP can receive payment authorization request(s) associated with the transaction(s) and cause (i) a first portion of the funds to be deposited as cryptocurrency into the cryptocurrency wallet account and (ii) a second portion of the funds to be deposited as fiat currency into the merchant account.

Thus, there is a need for a system and method that may overcome the deficiencies of cryptocurrencies to enable their wide adoption by the public.

### SUMMARY

Embodiments related to a system, a server platform, and a software development kit (SDK), and for processing payments using cryptographic currency are described hereinbelow by the way of example only.

One embodiment may include a system for processing payments using cryptographic currency, comprising a server platform configured to: receive from a payment terminal an invoice message that is comprised of a payment amount in a first currency; receive at least one or more crypto-addresses at a blockchain; ask a query on a blockchain network for a balance of a cryptocurrency in said at least one crypto address; establish a value of said balance in the first currency by applying at least one available exchange rate with said cryptocurrency type; respond to said invoice message by sending a crypto-payment offer message to a software development kit (SDK) installed on an electronic device and operably coupled to one or more one crypto wallets wallets of said at least one crypto address, wherein said crypto payment offer message comprises at least one payment amount in said at least one cryptocurrency type.

For example, the system comprising an electronic device wherein the electronic device is configured to: operably couple said SDK with at least one crypto-wallet having at least one crypto-address; transmit at least one crypto-address to said payment terminal; receive said crypto-payment offer message from said server platform;; approve said crypto-payment offer.

For example, wherein said at least one or more crypto-addresses is received with said invoice message from the payment terminal.

For example, the system comprising an electronic device wherein the electronic device is configured to: operably couple said SDK with at least one crypto-wallet having at least one crypto-address; transmit a user ID to said payment terminal for transmittal to said server platform with said invoice message; in response to a request from said server platform, return said at least one crypto-address; receive said crypto-payment offer message from said server platform; approve said crypto-payment offer.

For example, wherein said at least one payment amount in said at least one cryptocurrency of said crypto-payment offer message is determined based on at least one factor selected from: said value of said balance, preferences of cryptocurrency types; a risk factor of said at least one cryptocurrency type, transaction costs of said at least one cryptocurrency type.

For example, wherein upon approval of said crypto-payment offer by said SDK, said SDK instructing said at least one crypto-wallet to pay said at least one payment amount in said at least one cryptocurrency type, to a crypto-address of the server platform.

For example, wherein the electronic device is configured to: upon approval of said crypto-payment offer by said SDK, said SDK, informing the server platform of said approval.

For example, wherein said server platform paying said payment amount in a first currency of said invoice message to the POS.

For example, wherein said server platform is configured to exchange the received at least one payment amount in said at least one cryptocurrency for a sum in the first currency at a liquidity provider.

For example, the system comprising establishing a risk factor of a consumer based on at least one factor selected from: historical data of previous payments made by said consumer and verified alternative payment methods of said consumer available to said SDK.

For example, the system comprising transmitting said payment in the first currency to said POS before receipt of said at least one payment amount in said at least one cryptocurrency type, based on at least one factor selected from: risk factor of a consumer; risk factor of said at least one cryptocurrency type; network conditions of said at least one blockchain network of said at least one cryptocurrency type.

One embodiment may include a server platform comprising one or more tangible computer-readable non-transitory storage media comprising program instructions for processing payments using cryptographic currency, wherein execution of the program instructions by one or more processors causes the server platform to: receive from a payment terminal at a point of sale (POS) an invoice message that is comprised of a payment amount in a first currency and an at least one crypto-address of a least one crypto-wallet operably coupled with a software development kit (SDK) installed on a electronic device; query an at least one blockchain network for an at least one balance of an at least one cryptocurrency type in said at least one crypto-wallet; establish a value of said at least one balance in the first currency by applying at least one available exchange rate with said at least one cryptocurrency type; respond to said invoice message by sending a crypto-payment offer message to said SDK, wherein said crypto-payment offer message is comprised of at least one payment amount in said at least one cryptocurrency type.

For example, wherein said at least one or more crypto-addresses is received with said invoice message from the payment terminal.

For example, wherein said at least one or more crypto-addresses is received from said SDK in response to a request from said server platform to said SDK after receiving a user ID from said payment terminal.

For example, wherein execution of the program instructions by one or more processors causes the server platform to: generate said at least one payment amount in said at least one cryptocurrency type of said crypto-payment offer message based on at least one factor selected from: said value of said balance, preferences of cryptocurrency types; a risk factor of said at least one cryptocurrency type, transaction costs of said at least one cryptocurrency type.

For example, wherein, execution of the program instructions by one or more processors causes the server platform to: register in a database receipt of at least one payment amount in said at least one cryptocurrency type, to a crypto-address of the server platform.

For example, wherein upon receipt of said at least one payment amount in said at least one cryptocurrency type, execution of the program instructions by one or more processors result in: exchange the received at least one payment amount in said at least one cryptocurrency for a sum in the first currency at a liquidity provider.

For example, wherein upon receipt of said at least one payment amount in said at least one cryptocurrency type, execution of the program instructions by one or more processors causes the server platform to: pay said payment amount in a first currency of said invoice message to the POS.

For example, wherein execution of the program instructions by one or more processors causes the server platform to: establish a risk factor of a consumer based on at least one factor selected from: historical data of previous payments made by said consumer and verified alternative payment methods of said consumer available to said SDK.

For example, wherein execution of the program instructions by one or more processors causes the server platform to: transmit said payment in the first currency to said POS before receipt of said at least one payment amount in said at least one cryptocurrency type, based on at least one factor selected from: risk factor of a consumer; risk factor of said at least one cryptocurrency type; network conditions of said at least one blockchain network of said at least one cryptocurrency type.

One embodiment may include a electronic device comprising one or more tangible computer-readable non-transitory storage media having installed a software development kit (SDK) for processing payments using cryptographic currency wherein execution of the program instructions of the SDK by one or more processors results in: operably couple with at least one crypto-wallet having at least one crypto-address; transmit at least one crypto-address to a payment terminal at a point of sale (POS); receive a crypto-payment offer message from a server platform; wherein said crypto-payment offer message is comprised of at least one payment amount in said at least one cryptocurrency type; approve said crypto-payment offer; instruct said at least one crypto-wallet to pay said at least one payment amount in said at least one cryptocurrency type, to a crypto-address of the server platform.

For example wherein, execution of the program instructions of the SDK by one or more processors causes the electronic device to: to transmit said at least one crypto-address to a distant payment terminal via internet protocol.

For example, wherein, execution of the program instructions of the SDK by one or more processors causes the electronic device to: to transmit said at least one crypto-address to said payment terminal via near-field communication of the electronic device.

For example, wherein, execution of the program instructions of the SDK by one or more processors result in: upon approval of said crypto-payment offer by said SDK. said SDK. informing the server platform of said approval.

### BRIEF DESCRIPTION OF THE DRAWINGS

The disclosure can be more fully appreciated in connection with the following detailed description, taken in conjunction with the accompanying drawings, which:

FIG. 1 illustrates a block diagram of a system for processing payments using cryptographic currency, according to some demonstrative embodiments.

FIG. 2 illustrates a block diagram of a system for processing payments using cryptographic currency, according to some demonstrative embodiments.

FIG. 3 illustrates a flowchart of a method for processing payments using cryptographic currency, according to some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units, and/or circuits have not been described in detail so as not to obscure the discussion.

Discussions made herein utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing devices, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicate that different instances of like objects are being referred to and are not intended to imply that the objects so described must be in a given sequence, either temporally, spatially, in ranking, or any other manner.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some demonstrative embodiments, the circuitry may be implemented in, or functions associated with the circuitry may be implemented by one or more software or firmware modules. In some demonstrative embodiments, the circuitry may include logic, at least partially operable in hardware.

The term “module,” as used hereinbelow, is an object file that contains code to extend the running kernel environment.

The term “Software Development Kit,” as used hereinbelow, is a set of software tools that contain code enabling functionality and interfacing with other modules or applications and may include integrated modules, libraries, APIs, documentation, and communication protocols, etc.

Some demonstrative embodiments may build on the web3 ecosystem concept and blockchain technology. For example, the web3 ecosystem concept and blockchain technology establish a secure, transparent, and decentralized payment system. The use of a blockchain enables consumers and businesses to directly exchange cryptocurrency, such as, for example, Bitcoin and Ethereum, via crypto wallets without intermediaries. The payment is verified and anonymously registered on a distributed ledger, wherein, for example, a copy of which may be stored on a crypto wallet.

For example, the ownership verification of the crypto-wallet and its funds may be achieved by using private-public keys, as the basic assumption is that only the owner of the crypto wallet has access to the private key, making the public key available for use as a unique wallet identifier.

More than a decade after the first implementation of the Bitcoin blockchain, the technology struggles to gain adoption as a consumer payment method and remains mostly a speculative investment channel.

There are many reasons why Blockchain technology and cryptographic currency have yet to achieve the purpose of becoming a viable alternative to traditional centralized payment means and legal tender.

As used hereinbelow, the term “crypto-wallet” may refer to an application, a module, a backend application, a server side SDK, or an API configured to generate and store random private-public key pairs with a respective crypto-wallet address generated from the public key. The crypto-wallet may be further configured to interact and facilitate payments with at least one blockchain network, such as, for example, the Ethereum blockchain and other similar blockchain networks, such as, for example, Bitcoin, Solana, Cardano, Polkadot, Avalanche, etc.

The term “cryptocurrency” as used hereinbelow, may refer to fungible cryptocurrencies, such as, for example, Bitcoin, ETH and Sol, or other tokens that are built on blockchain concepts and technologies.

The term “Payment terminal,” as used hereinbelow, may include, for example, the credit card terminal of a specific merchant and/or vendor and/or shop and/or etc., on which various payment transactions can be made when a consumer decides to consume a payment transaction using a payment card or other type of payment means. In some demonstrative embodiments, the payment terminal may be configured as a software application or SDK in online payment processing software for use in e-commerce and online shopping.

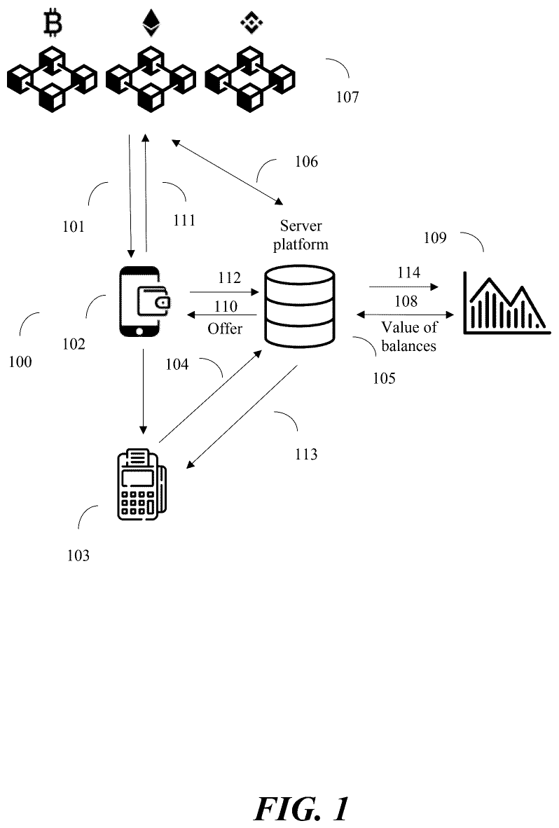

Referring initially to FIG. 1 depicting a demonstrative embodiment of the present disclosure. A system 100 for processing payments using cryptographic currency.

The system comprises a software development kit (SDK) operably coupled with at least one crypto-wallet having at least one crypto-address, installed on a electronic device 102, wherein, said SDK may be configured to transmit 104 at least one crypto-address to a payment terminal 103 at a point of sale (POS) (not shown).

In some demonstrative embodiments, payment terminal 103 that may be configured to transmit (shown by line 104) to a server platform 105 an invoice message that may be comprised of a payment amount in a first currency, for example, US Dollars, and said at least one crypto-address, for example, two crypto-addresses of Ethereum blockchain and a single crypto-address of Bitcoin blockchain.

In some demonstrative embodiments, system 100 may comprise the server platform 105 that may be configured to query (shown by line 106) an at least one blockchain network 107 for an at least one balance of an at least one cryptocurrency type in said at least one crypto-wallet. For example, by instructing a crypto-wallet module to interact with the blockchain and get balances of tokens associated with a crypto-wallet.

For example, server platform 105 may be configured to establish a value of said at least one balance in the first currency, e.g., US Dollars, by applying (shown by line 108) at least one available exchange rate from a liquidity provider (shown by line 109), e.g., USD-Bitcoin exchange rate, with said at least one cryptocurrency type, for example, a Bitcoin, Ethereum (ETH) and the like.

For example, the value of crypto-currency tokens may be established by multiplying the number of tokens (e.g., 2.5 ETH) with an available exchange rate to the currency of the invoice message (e.g., 1,500 US Dollars). For example, the available exchange rate may be discounted by a partner company such as a liquidity provider (shown by line 109) to allow profit margins. A liquidity provider (shown by line 109) may be a third party exchange dealing with cryptographic currencies.

In some demonstrative embodiments, server platform 105 may respond (shown by line 110) to said invoice message by sending a crypto-payment offer message to said SDK, for example, said crypto-payment offer message may include of at least one payment amount in said at least one cryptocurrency type, e.g., Bitcoin.

For example, upon approval of said crypto-payment offer by said SDK, said SDK may instruct said at least one crypto-wallet to pay (shown by line 111) said at least one payment amount, in said at least one cryptocurrency type, e.g., 1.5 ETH, to a crypto-address of the server platform 105.

In some demonstrative embodiments, upon approval of said crypto-payment offer by said SDK, said SDK may inform the server platform of said approval (shown by line 112). This functionality enables the system to decide for example to pay payment amount in said currency of the invoice message before receipt of payment in in said at least one cryptocurrency type.

For example, upon receipt of said at least one payment amount in said at least one cryptocurrency type, e.g., 1.5 ETH, said server platform may be configured to pay (shown by line 113) said payment amount in a first currency (e.g., US Dollars) of said invoice message to the payment terminal 103 of the POS (not shown).

In some demonstrative embodiments, the server platform may exchange (shown by line 114) at least one payment amount in said at least one cryptocurrency type, e.g., 1.5 ETH for a sum in the first currency at the liquidity provider 109.

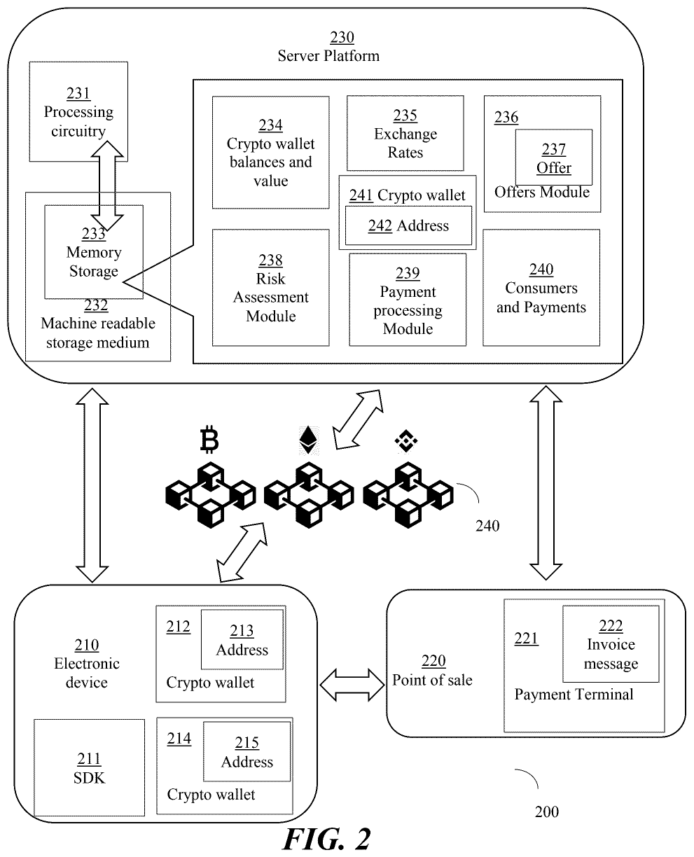

Referring to FIG. 2 depicting a demonstrative embodiment of the present disclosure.

In some demonstrative embodiments, a memory storage 233 may be included one or more tangible machine-readable non-transitory storage medium 232. The one or more tangible machine-readable non-transitory storage medium 232 may include computer-executable instructions, operable to, when executed, for example, by at least one computer processor and/or processing circuitry 231. For example, the one or more tangible machine-readable non-transitory storage medium 232, may enable the at least one processing circuitry 231 to implement one or more program instructions for processing payments using cryptographic currency and/or to perform, trigger and/or implement one or more operations, communications and/or functionalities as described herein with reference to FIGS. 1-3. The phrase “non-transitory machine-readable medium” is directed to include all computer-readable media, with the sole exception being a transitory propagating signal.

In some demonstrative embodiments, a server platform 230 may be a central computer, a server cluster, or software running on a cloud server of a service provider. The server platform 230 may provide services to client computers, such as, for example, payment terminals 221 and electronic devices that comprise SDK and may include a machine-readable storage medium 232 that comprises one or more types of computer-readable storage medium capable of storing data, including volatile memory, non-volatile memory, removable or non-removable memory, erasable or non-erasable memory, writeable or re-writeable memory, and the like. For example, the machine-readable storage medium 232 may include any type of memory, such as, for example, RAM, DRAM, ROM, programmable ROM (PROM), erasable programmable ROM (EPROM), electrically erasable programmable ROM (EEPROM), Flash memory, a hard disk drive (HDD), a solid-state disk drive (SDD), fusion drive, and the like. The computer-readable storage media 232 may include any suitable medium involved with downloading or transferring a computer program from a remote computer to a requesting computer carried by data signals embodied in a carrier wave or other propagation medium through a communication link, e.g., a modem, radio, or network connection.

In some demonstrative embodiments, server platform 230 may include or may be implemented as software, firmware, a software module, an application, a program, a subroutine, instructions, an instruction set, computing code, words, values, symbols, and the like. Instructions may include any suitable types of code, such as source code, compiled code, interpreted code, executable code, static code, dynamic code, and the like. Instructions may be implemented according to a predefined computer language, manner and/or syntax for instructing a processor to perform a specific function. The instructions may be implemented using any suitable high-level, low-level, object-oriented, visual, compiled, and/or interpreted programming languages, such as C, C++, C #, Java, Python, BASIC, Mat lab, assembly language, machine code, and the like.

In some demonstrative embodiments, an SDK 211 is installed on an electronic device 210. For example, the Electronic device 210 may be a personal computer, a smartphone and/or a tablet computer. The SDK 211 may be implemented in various programming languages compatible with the operating system of the electronic device 210.

In some demonstrative embodiments, the SDK 211 may be operably coupled to at least one Crypto-wallet 212, 214, each having at least one Crypto-Address 213, 215. For example, the operable coupling of the SDK 211 and crypto-wallet may be through integration, as a software module in the SDK 211 but may also be through the means of gaining access and control permissions from a crypto-wallet 214 application (e.g., Metamask™) installed on the same electronic device 210 or a different electronic device.

In some demonstrative embodiments, the SDK 211 may contain instructions to transmit at least one crypto-address 213 215 to a payment terminal 221 at a Point of sale (POS) 220.

In some demonstrative embodiments, the payment terminal 221 and POS 220 may be in a physical location such as a restaurant or a store, in which case, the payment terminal 221 may be a payment processing computer as employed for processing credit card payments. In that case the SDK 211 may use a Near-Field Communication (NFC) of the electronic device 210 to transmit SDK's identifying information that may comprise the crypto-wallet address.

It is understood, that the POS 220 may be in a distant location and a purchase may be made on an online store. For this scenario, the SDK 211 may include instructions to transmit required information through internet protocols to a payment terminal 221 that may be implemented as a software module or an API employing the functionality described herein.

For example, payment terminal 222 may receive crypto-address 213 and other information, such as, for example, metadata, from the SDK 211 and payment-related data from the POS 220, for example, the sum to be paid and a goods list from a checkout register.

In some demonstrative embodiments, payment terminal 221 may generate an invoice message 222. For example, invoice message 222 may include a JSON file containing structured information readable by a server platform 230.

For example, the invoice message 222 may include identifying information, such as, for example, the identity of the POS 220, a user ID operating the SDK 211, the crypto-addresses of the consumer 213, and their respective blockchains 240.

For example, invoice message 222 may include payment information such as, for example, payment amount in a first currency and a list of goods to be paid for.

For example, invoice message 222 may include the following illustrative information: 50 Euros as the payment amount in the first currency, vendor account name, 2 crypto-addresses of the Ethereum blockchain, and 1 crypto-address of the Bitcoin network.

In some demonstrative embodiments, payment terminal 221 may be configured to transmit to server platform 230 invoice message 222. For example, contents of invoice message 222 may be retrieved and stored in a Consumers and Payments database.

In some demonstrative embodiments, balances of cryptocurrencies in crypto- wallets 214 indicated in the invoice message 222 may be queried by accessing blockchains 240 of the crypto-address 213.

In some demonstrative embodiments, querying the blockchains 240 may be performed for validating purposes, as the SDK may include instructions to interact with the crypto-wallet 212 and access the balance information directly, thereafter providing the balance information to the server platform 230.

In some demonstrative embodiments, values of crypto-wallet balances may be established by applying data from an exchange rates database 235 that may be updated as needed from various sources such as, for example, exchange rates provided by liquidity providers providing exchange services to various cryptocurrencies.

In some demonstrative embodiments, the memory storage 233 may include a crypto-wallet balances and value database 234 comprising information regarding crypto-addresses 213 associated with consumers, balances of cryptocurrencies in crypto-wallets 214, and their values in traditional currencies.

In some demonstrative embodiments, the memory storage 233 may include an Offers module 236 that contains instructions to generate and transmit a crypto-payment offer message 237 to the SDK 211, in response to the invoice message 222. For example, a JSON file containing structured information readable by an application built with the SDK 211.

For example, the crypto-payment offer message 237 may be comprised of at least one payment amount in said at least one cryptocurrency type.

For example, based on the balance values established, the Offers module 236 may generate a crypto-payment offer message 237 to the consumer to exchange purchased goods for cryptocurrencies in his crypto-wallets. This functionality may be especially useful as vendors may be reluctant to accept cryptocurrency directly, while owners of cryptocurrency may be reluctant to deposit their cryptocurrencies in accounts held by a third party.

In some demonstrative embodiments, at least one payment amount in at least one cryptocurrency type of said crypto-payment offer message may be a plurality of payment amounts in a plurality of cryptocurrencies. For example, an offer 237 may be generated that includes three payments in different cryptocurrencies on different blockchains. For example, an offer to cover the purchase of a car may be made for a dozen ETH and several Bitcoins with values using all digits after the decimal.

In some demonstrative embodiments, the at least one payment amount in at least one cryptocurrency type of said crypto-payment offer message may be determined based on at least one factor selected from the value of said at least one balance, preferences of cryptocurrency types, for example, a list of preferred types or a black-list of forbidden types; a risk factor of cryptocurrencies, profit margin rate, transaction costs of cryptocurrencies, for example, GAS costs.

For example, the composition of payments in cryptocurrencies may be established to provide an optimal compromise between various often competing factors such as, for example, server platform 230 may have access to preferable exchange rates from some cryptocurrencies, while transaction costs may not be low enough at the time of the payment. Other considerations may include volatility conditions on some cryptocurrencies that may affect the payment composition.

In some demonstrative embodiments, the SDK 211 may include instructions to receive offer messages 237 and prompt the consumer to approve the offer, for example by displaying the offer and listening to an approval event via a front-end user interface.

In some demonstrative embodiments, the SDK 211 may include instructions that upon approval of said crypto-payment offer 237, instructing said at least one crypto-wallet 212, 214 to pay said at least one payment amount in said at least one cryptocurrency type, to a crypto-address 242 in a crypto-wallet 241 of the server platform 230.

Advantageously, a feature of the system disclosed herein is that a consumer may not be required to manually input a plurality of payment amounts in cryptocurrencies that may often include 18 digits after the decimal. This feature may combine user error prevention with utility and ease of use, all while retaining the cryptocurrency balance in a wallet held by the consumer and not by a third-party company.

In some demonstrative embodiments, upon approval of said crypto-payment offer 237 by said SDK 211, said SDK 211 may inform the server platform 230 of said approval.

In some demonstrative embodiments, the server platform 230 may include a Payment processing module 239 that includes instructions to pay the payment amount in the first currency of said invoice message 222 to the POS 220. For example, upon receipt of said at least one payment amount in said at least one cryptocurrency type.

In some demonstrative embodiments, the Payment processing module 239 may include instructions to pay the POS 220 before all payment amounts of cryptocurrencies may be received in crypto-wallets of the server platform 230. For example, if latency of one of the blockchains doesn't allow for an immediate transaction, the server platform shall pay the POS 220 the amount of the invoice message 222 even if confirmation of the cryptocurrency payment is still unavailable.

In some demonstrative embodiments, the Payment processing module 239 may include instructions to instruct the SDK 211 to delay payment of at least one payment amount in at least one cryptocurrency type. For example, if transaction costs of a cryptocurrency type are not optimal while the consumer has low-risk factor, the server platform 230 may pay the POS 220 the amount of the invoice message 222.

In some demonstrative embodiments, the Payment processing module 239 may include instructions to exchange the received at least one payment amount in said at least one cryptocurrency for a sum in the first currency at the liquidity provider (not shown). For example, resulting in limiting the exposure of the server platform operator to cryptocurrency.

In some demonstrative embodiments, the server platform 230 may include a Risk Assessment Module 238 that includes instructions to establish a risk factor of a consumer based on at least one factor selected from: historical data of previous payments made by said consumer and verified alternative payment methods of said consumer available to said SDK 211.

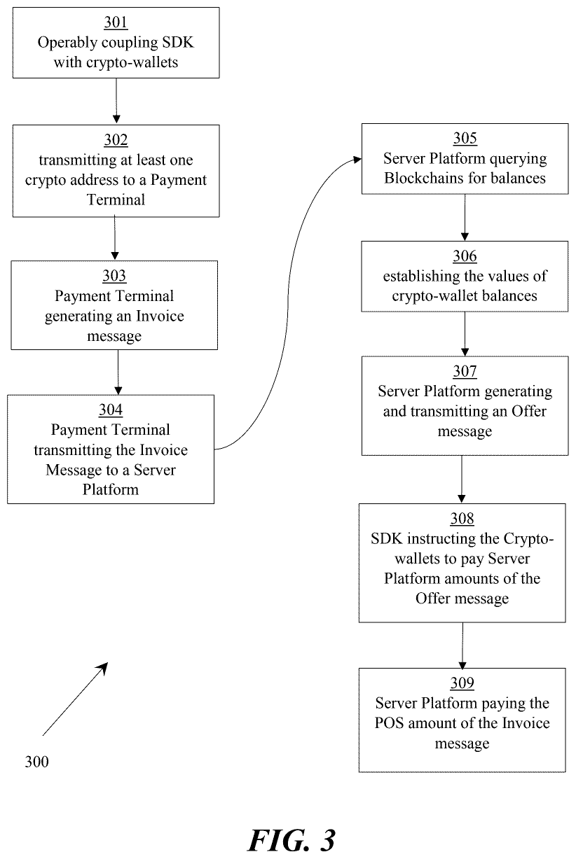

Referring to FIG. 3, which is an illustration of a flowchart of a method for processing payments using cryptographic currency, according to some demonstrative embodiments. For clarity, structural components are referred to by their references in FIG. 2, though this method can be performed with other embodiments.

In some demonstrative embodiments, the method 300 may start with operably coupling the SDK 211 with at least one crypto-wallet 212, 214, each having at least one crypto-Address 213, 215 (text box 301).

In some demonstrative embodiments, the method 300 may proceed with the SDK 211 transmitting at least one crypto-address 213, 215 to a payment terminal 221 at a Point of sale (POS) 220 (text box 302).

In some demonstrative embodiments, the method may proceed (not shown) with the SDK 211 transmitting a user ID to the payment terminal 221 at the Point of sale (POS) 220. For example, for the payment terminal 221 transmitting the user ID with the invoice message 222. For example, in later stages of the method, the server platform 230 may send a request to an SDK 211 to provide a list of at least one crypto address 213 of crypto wallets 212 coupled to the SDK. For example, in later stages of the method, the SDK 211 in response to the request, may send the server platform 230, the list of at least one crypto address 213.

In some demonstrative embodiments, the method 300 may proceed with the payment terminal 221 generating an invoice message 222. For example, invoice message 222 may include the crypto-addresses of the consumer 213 and payment amount in a first currency (text box 303).

In some demonstrative embodiments, method 300 may proceed with Payment Terminal 221 transmitting the invoice Message 222 to server platform 230 (text box 304).

In some demonstrative embodiments, method 300 may proceed with the server platform 230 querying the blockchains 240 of the crypto-address 213 for balances of cryptocurrencies in crypto-wallets 214 indicated in an invoice message 222 (text box 305).

In some demonstrative embodiments, method 300 may proceed with establishing the values of crypto-wallet balances by applying data from the available exchange rates database 235 (text box 306).

In some demonstrative embodiments, method 300 may proceed with generating and transmitting to the SDK 211, a crypto-payment offer message 237 in response to invoice Message 222. For example, the crypto-payment offer message 237 may be comprised of at least one payment amount in said at least one cryptocurrency type (text box 307).

In some demonstrative embodiments, method 300 may proceed with the SDK 211, upon approval of said crypto-payment offer 237, instructing said at least one crypto-wallet 212, 214 to pay said at least one payment amount in said at least one cryptocurrency type to a crypto-address 242 of the server platform 230 (text box 308).

In some demonstrative embodiments, method 300 may proceed with the server platform 230 paying the payment amount in the first currency of said invoice Message 222 to POS 220 (text box 309). For example, upon receipt of said at least one payment amount of tokens in the cryptocurrency type.

The subject matter described above is provided by way of illustration only and should not be construed as limiting. Various modifications and changes can be made to the subject matter described herein without following the example embodiments and applications illustrated and described and without departing from the true spirit and scope of the present disclosure, which is set forth in the following claims.

What is claimed:

1. A system for processing payments using cryptographic currency, comprising a server platform configured to:
receive from a payment terminal at a point of sale (POS) an invoice message that is comprised of a payment amount in a first currency and a plurality of crypto-addresses at an at least one blockchain;
ask a query on said at least one blockchain for a balance of cryptocurrencies in said plurality of crypto-addresses;
establish a value of said balance in the first currency by applying at least one available exchange rate with said cryptocurrencies;
respond to said invoice message by sending a crypto-payment offer message to a software development kit (SDK) installed on an electronic device and operably coupled to a one or more crypto-wallet that contains said plurality of crypto-addresses, wherein said crypto-payment offer message comprises a plurality of payment amounts in said plurality of cryptocurrencies; wherein, said plurality of payment amounts are determined based on at least one factor selected from: said value of said balance, preferences of cryptocurrency types; a risk factor of said at least one cryptocurrency type, a risk factor of a consumer transaction costs of said plurality of cryptocurrencies.

2. The system of claim 1 comprising an electronic device wherein the electronic device is configured to:
operably couple said SDK with at least one crypto-wallet having at least one crypto-address;
transmit said plurality of crypto-addresses to said payment terminal;
receive said crypto-payment offer message from said server platform;
approve said crypto-payment offer.

3. The system of claim 2, wherein the electronic device is configured to: upon approval of said crypto-payment offer by said SDK, said SDK instructing said at least one crypto-wallet to pay said plurality of payment amounts in said plurality of cryptocurrencies, to a crypto-address of the server platform.

4. The system of claim 2, wherein the electronic device is configured to: upon approval of said crypto-payment offer by said SDK, said SDK, informing the server platform of said approval.

5. The system of claim 1, wherein said server platform is configured to pay said payment amount in the first currency of said invoice message to the POS.

6. The system of claim 1, wherein said server platform is configured to exchange the received plurality of payment amounts in said plurality of cryptocurrencies for a sum in the first currency at a liquidity provider.

7. The system of claim 1, wherein the server platform is configured to:
establish a risk factor of a consumer based on at least one factor selected from historical data of previous payments made by said consumer and verified alternative payment methods of said consumer available to said SDK.

8. The system of claim 2, wherein the server platform is configured to:
transmit said payment in the first currency to said POS before receipt of said at least one payment amount in said at least one cryptocurrency type, based on at least one factor selected from: risk factor of a consumer; risk factor of said at least one cryptocurrency type; network conditions of said at least one blockchain network of said at least one cryptocurrency type.

9. A server platform comprising one or more tangible computer-readable non-transitory storage media comprising program instructions for processing payments using cryptographic currency, wherein execution of the program instructions by one or more processors result in:
receive from a payment terminal at a point of sale (POS) an invoice message that is comprised of a payment amount in a first currency and a plurality of crypto-addresses of at least one crypto-wallet operably coupled with a software development kit (SDK) installed on a electronic device;
query an at least one blockchain network for a balance of plurality of cryptocurrencies in said at least one crypto-wallet;
establish a value of said at least one balance in the first currency by applying at least one available exchange rate with said cryptocurrencies;
respond to said invoice message by sending a crypto-payment offer message to said SDK, wherein said crypto-payment offer message is comprised of a plurality of payment amounts in said plurality of cryptocurrencies; wherein, said plurality of payment amounts are determined based on at least one factor selected from: said value of said balance, preferences of cryptocurrency types; a risk factor of said at least one cryptocurrency type, a risk factor of a consumer transaction costs of said plurality of cryptocurrencies.

10. The server platform of claim 9, wherein, execution of the program instructions by one or more processors result in:
register in a database receipt of at least one payment amount in said plurality of cryptocurrencies, to a crypto-address of the server platform.

11. The Server Platform of claim 9, wherein upon receipt of said plurality of payment amounts in said plurality of cryptocurrencies, execution of the program instructions by one or more processors result in:
exchange the received payment amounts for a sum in the first currency at a liquidity provider.

12. The Server Platform of claim 9, wherein upon receipt of said plurality of payment amounts in said plurality of cryptocurrencies, execution of the program instructions by one or more processors result in:
pay said payment amount in the first currency of said invoice message to the POS.

13. The server platform of claim 9, wherein, execution of the program instructions by one or more processors result in:
establish a risk factor of a consumer based on at least one factor selected from: historical data of previous payments made by said consumer and verified alternative payment methods of said consumer available to said SDK.

14. The server platform of claim 9, wherein, execution of the program instructions by one or more processors result in:
transmit said payment in the first currency to said POS before receipt of said plurality of payment amounts in said plurality of cryptocurrencies, based on at least one factor selected from: risk factor of a consumer; risk factor of said at least one cryptocurrency type; network conditions of said at least one blockchain network of said at least one cryptocurrency type.

15. An electronic device comprising one or more tangible computer-readable non-transitory storage media having installed a software development kit (SDK) for processing payments using cryptographic currency, wherein execution of the program instructions of the SDK by one or more processors results in:
transmitting a plurality of crypto-addresses of at least one crypto-wallet to a payment terminal;
receiving a crypto-payment offer message from a server platform, wherein said crypto-payment offer message comprises a plurality of payment amounts in said plurality of cryptocurrencies; wherein, said plurality of payment amounts are determined based on at least one factor selected from: said value of said balance, preferences of cryptocurrency types; a risk factor of said at least one cryptocurrency type, a risk factor of a consumer transaction costs of said plurality of cryptocurrencies;
approving said crypto-payment offer;
instructing said at least one crypto-wallet to pay said plurality of payment amounts in said plurality of cryptocurrencies, to a crypto-address of the server platform.

16. The electronic device of claim 15 wherein, execution of the program instructions of the SDK by one or more processors result in:
to transmit said plurality of crypto-addresses to a distant payment terminal via internet protocol.

17. The electronic device of claim 15 wherein, execution of the program instructions of the SDK by one or more processors result in:
to transmit said plurality of crypto-addresses to said payment terminal via near-field communication suite of the electronic device.

18. The electronic device of claim 15 wherein, execution of the program instructions of the SDK by one or more processors result in:
upon approval of said crypto-payment offer by said SDK, said SDK, informing the server platform of said approval.
